(19) United States
(12) Patent Application Publication
(10) Pub. No.: US 2022/0094882 A1
(43) Pub. Date: Mar. 24, 2022

(54) Towed Underwater Image Acquisition System, Apparatus And Method

(71) Applicants: Shiwei Liu, Lehi, UT (US); Xiaoge Cheng, Beijing (CN); Qiaowei Liu, Lianyungang (CN); Riming Hao, Beijing (CN)

(72) Inventors: Shiwei Liu, Lehi, UT (US); Xiaoge Cheng, Beijing (CN); Qiaowei Liu, Lianyungang (CN); Riming Hao, Beijing (CN)

(21) Appl. No.: 17/401,388

(22) Filed: Aug. 13, 2021

Related U.S. Application Data
(60) Provisional application No. 63/079,133, filed on Sep. 16, 2020.

(51) Int. Cl. H04N 7/18; H04N 5/225; H04N 5/235; G03B 17/56; B63B 45/02; B63B 79/10; B63G 8/42; B63B 21/66; B63B 21/20; B63B 21/04; G01S 19/42; B63G 8/38

(52) U.S. Cl. CPC H04N 7/183; H04N 5/2256; H04N 5/2351; H04N 5/2354; G03B 17/561; B63B 45/02; B63G 8/38; B63G 8/42; B63B 21/66; B63B 21/20; B63B 21/04; G01S 19/42; B63B 79/10

(57) ABSTRACT

The current invention, in some embodiments thereof, relates to a tow unit 1 and image acquisition apparatus (or ‘platform’, or ‘the platform’) 2. The tow unit comprises of an attachment mechanism 10, provided for the attachment of the cabling 3. The cabling 3 comprises of a tow ball 4, typically immersed in water in the water body 5. Further in the same figure is an image acquisition apparatus 2 with an attachment means or mechanism 20, provided for the attachment of the cabling 3 and by extension, the tow unit 1.

### FIELD OF INVENTION

The current invention relates in some embodiments thereof, to an image acquisition apparatus, and in particular, to a towed underwater image acquisition apparatus.

### RELATED APPLICATIONS

In some aspects, this application may claim benefit from patent applications and prior art literature including:

U.S. Ser. No. 10/683,069B2: An underwater exploration system enables signal transmission and reception to and from an underwater vehicle through wireless communication, that enables carriage of the underwater vehicle to a survey point and collection of the underwater vehicle, and, further, that enables a quick change of the survey point. The underwater exploration system includes: an underwater exploration unit including: a floating member including a first antenna and configured to support the first antenna above a water surface; and an underwater vehicle connected to the first antenna via a signal line; a communication device including a second antenna configured to transmit and receive a wireless signal to and from the first antenna; and an unmanned aerial vehicle configured to carry the underwater exploration unit and drop the underwater exploration unit to the water surface.

U.S. Pat. No. 9,498,883B2: Disclosed is an underwater exploration system using a multi joint underwater robot having a novel complex movement concept in which the multi joint underwater robot moves through walking or swimming with multi joint legs closely to a seafloor, differently from a conventional underwater robot to obtain a thrust through a propeller scheme. The underwater exploration system includes the multi joint underwater robot having the complex movement function according, a depressor, and a mother ship to store data of an underwater state transmitted from the multi joint underwater robot and to monitor and control a movement direction of the multi joint underwater robot. The depressor is connected to the mother ship through a primary cable, the multi joint underwater robot is connected to the depressor through a second cable, and resistance force of the primary cable is applied to the depressor without being transmitted to the multi-joint underwater robot.

U.S. Pat. No. 8,864,326B2: An underwater diving light has a rotatable front filter ring for selecting light filtration as needed for underwater still or video photography conditions. The filter ring is removable and interchangeable with different rings. Another important feature is efficient cooling of the LEDs and other internal electronics of the diving light assembly. The water is in contact with a metallic front face that conducts heat directly away from a metal core circuit board carrying the LED array or arrays. In one form of the diving light water channels are provided so that the ambient water can enter the assembly to spaces behind the LCD circuit board to efficiently cool the LEDs and associated electronics. The front plate assembly can be removable, for rinsing the internal cooling cavities, for interchange with different front face assemblies, and for air travel when the LCDs must be removed from driving electronics for safety concerns.

U.S. Pat. No. 7,520,629B2: A flashlight is provided comprising a LED illumination source, a power source electrically coupled to said LED illumination source, and a solid body encapsulating the power source and at least a portion of the LED illumination source. The invention further includes an underwater illumination system comprising a glove having an interior, an inner surface, and an outer surface, and an underwater flashlight comprising a LED illumination source, a power source electrically coupled to the LED illumination source, a solid body encapsulating the power source and at least a portion of the LED illumination source, and a securing member for connecting the underwater flashlight to said glove. A method for making an underwater, pressure-resistant LED flashlight is provided for making an encapsulating solid body for the elements providing illumination.

KR101488216B1: The present invention relates to a sub-bottom profiler to analyze the structure of the seabed using sound waves. The present invention provides a hull-mounted sub-bottom profiler system; and the sub-bottom profiler system and methods of the related art are subject to the problems of the sub-bottom profiler impairment or missing due to the obstacles such as fisheries which has resulted in the costs for equipment repair, replacement, and time damage due to equipment recovery; as the sub-bottom profiler is pulled while hung to the back of a ship or is used mounted on the side surface of the hull using an installation frame. However, in accordance to the present invention, a space is formed in the vicinity of the center of a lower end of the ship and a sub-bottom profiler installation box is produced such that the sub-bottom profiler is mounted on the space to prevent damage or loss due to fisheries or obstacles. Also, shaking due to waves or tides is reduced while the bottom surface of the box is formed of an FRP material such that the transducer is not exposed outside, and the transducer be protected. The transducer and the bottom surface are completely sealed such that no space is formed between the transducer and the bottom surface, which allows noise to be reduced. In addition, the inner space of the box is filled with seawater such that the profiling can be performed in the environments identical to the external environments which results in higher profiling accuracy.

### BACKGROUND OF THE INVENTION

Underwater photographing is an important research direction of underwater optics and marine optics, is an important means and tool for mankind to know, exploit and utilize, and protect the sea, and has advantages such as intuitive target detection, high imaging resolution, and high information content. The technique is widely applied to fields such as underwater target reconnaissance/detection/recognition, underwater archaeology, submarine resource exploration, bioresearch, underwater engineering installation/overhaul, underwater environment monitoring, and lifesaving and salvage.

The existing underwater imaging technique includes a submarine towed sonar system, which describes submarine topography information by means of sonar echo information. However, such technique has the problem in distinguishing submarine creatures from submarine rocks, and fast-moving creatures such as shrimps and crabs cannot be distinguished. In addition, the existing underwater imaging technique further includes acquiring an underwater image by fixedly providing a camera at the bottom of the sea. The fixed camera cannot be moved and has a small visual range, making it impossible to observe a large area of the sea. In order to solve the above defects and deficiencies in the prior art, a towed underwater image acquisition apparatus is provided.

### SUMMARY

The following summary is an explanation of some of the general inventive steps for the device, method, manufacture and apparatus in the description. This summary is not an extensive overview of the invention and does not intend to limit the scope beyond what is described and claimed as a summary.

The current invention, in some embodiments thereof, relates to a tow unit and image acquisition apparatus (or ‘platform’, or ‘the platform’). The tow unit comprises of an attachment mechanism, provided for the attachment of the cabling. The cabling comprises of a tow ball, typically immersed in water in the water body.

According one embodiment, a tow unit comprises of an attachment means, which is provided for the attachment of the cabling. Further is a tow ball control provided, which for purposes of this disclosure provides a mechanism of moving the tow ball along the cabling length, where preferably but not necessarily, it is an iron tow ball added to the cabling, wherein one section of the cable is attached to the attachment means and to the underwater image acquisition apparatus by a second section of the cable to the attachment means, and as such, influencing the underwater image acquisition apparatus' buoyancy, thereby determining the height and range of the platform's movement. For example, by moving the tow ball closer to the platform, it causes the platform to sink deeper underwater, while moving the tow bar away from the platform causes the buoyant platform to rise closer to the surface.

According to another embodiment, an operation mechanism is provided, which may be configured to communicate with the processor unit and configured to send an instruction for the operation of the control module thereof. It may be further configured capable of operating the cable control, tow ball control. As one example, the cable control may receive an instruction from the operation mechanism to wind or unwind the cabling, where such winding causes the platform to acquire a different relative position from the tow unit. In another example, tow ball control may receive an instruction from the operation mechanism to move the tow ball along the length of the cable using a suitable mechanism, such as but not limited to internal gears in the tow ball, rollers, wheels of any such. It is also anticipated that other mechanisms are applicable to this invention that would enable the moving of the tow ball along the length of the cabling. Further still is a propulsion means, which for purposes of this disclosure may be one or more of: movement of the tow unit, for example by an engine, or movement of the platform, for example by means of a cabling winding or a tractor or any such mechanism capable of pulling the platform and causing a displacement of it in the water.

According to another embodiment, an underwater image acquisition system comprises of an attachment means, which is provided for the attachment of the cabling at a corresponding attachment means, an image acquiring apparatus capable of underwater image acquisition, and this may be an optical camera, a general sensor, an infra-red sensor, any such apparatus capable of image acquisition underwater, including radar, sonar, electromagnetic sensors, among others. Also comprised is a positioning means capable of determining the position of the underwater image acquisition system relative to a known position, and this is preferably relative to the tow unit. Nonetheless, in some embodiments, the positioning means comprises of a satellite positioning receiver or any such receivers that may include any one of GPS, GLONASS, NavIC, BeiDou, Galileo, Quasi-Zenith, and which determine the longitude and latitude information of the unit. In other embodiments, the positioning means comprises of a means of determining the position of the underwater image acquisition system relative to the tow unit. As a consequence, an acquired image's position may further be determined by means of a positioning means supplied thereof.

Further details and embodiments and methods are described in the detailed description below.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the diagrams illustrates a tow unit and image acquisition apparatus according to one embodiment of the current invention.

FIG. 2 of the diagrams illustrates a block diagram of some constituent elements of a tow unit according to one embodiment of the current invention.

FIG. 3 of the diagrams illustrates a block diagram of some constituent elements of an image acquisition apparatus according to one embodiment of the current invention.

FIG. 4 of the diagrams illustrates an image acquisition apparatus of a sledge type configuration.

FIG. 5 of the diagrams illustrates an image acquisition apparatus of a wheeled type configuration.

FIG. 6 of the diagrams illustrates a process of adapting the light intensity produced by a lighting module at an image acquisition apparatus.

FIG. 7 of the diagrams illustrates a process of adapting the relative position of an image acquisition apparatus.

### DETAILED DESCRIPTION OF THE DRAWINGS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not expressly limit the technical spirit and scope of this invention. Accordingly, it should be understood that various changes and modifications may be made to the invention without departing from the spirit and scope thereof.

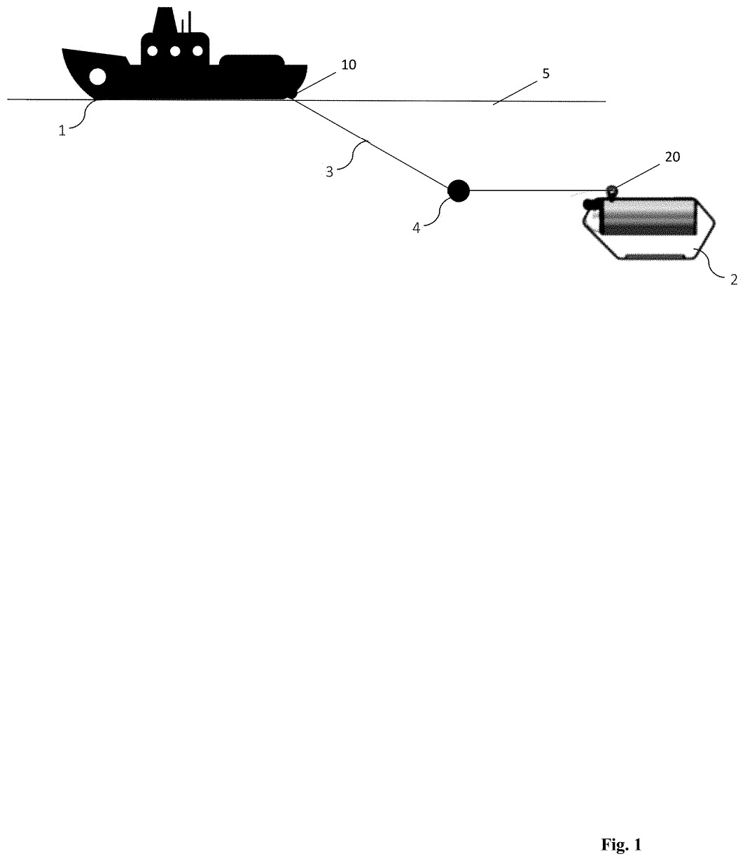

In a first embodiment according to FIG. 1 of the diagrams it is illustrated a tow unit 1 and image acquisition apparatus (or ‘platform’, or ‘the platform’) 2 according to one embodiment of the current invention. The tow unit comprises of an attachment mechanism 10, provided for the attachment of the cabling 3. The cabling 3 comprises of a tow ball 4, typically immersed in water in the water body 5. Further in the same figure is an image acquisition apparatus 2 with an attachment means or mechanism 20, provided for the attachment of the cabling 3 and by extension, the tow unit 1. While it is preferred that the tow unit is a ship or any such water-based vessel, this specification does not intent to limit the scope of what a tow unit could comprise of as it could also be a land-based vehicle, a crane or any other mechanism, with the ability to provide a means of propulsion to the underwater image acquisition apparatus, and as such, they are anticipated as well. For purposes of this illustration, the tow unit may also be referred to as a shore-based controller.

According to an exemplary embodiment, the tow unit disclosed provides for a means of controlling the image acquisition apparatus 2 as well as providing a means of propulsion of the same, preferably via the cabling provided thereof. It is also provided for the control of the cabling via a cabling control mechanism thereof, and control the tow ball via a tow ball control mechanism thereof.

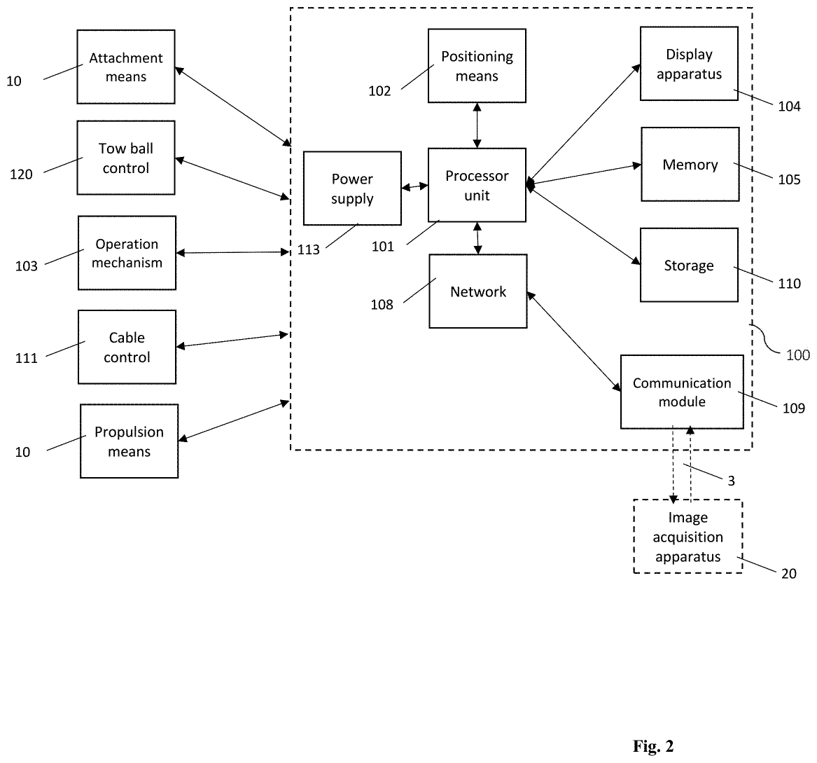

According to a second non-limiting embodiment illustrated by the FIG. 2 of the diagrams is a block diagram of some constituent elements of a tow unit according to one embodiment of the current invention. Illustrated in the figure is an attachment means 10, which is provided for the attachment of the cabling 3 described in the previous FIG. 1. Further is a tow ball control 120, provided, which for purposes of this disclosure provides a mechanism of moving the tow ball along the cabling length, where preferably but not necessarily, it is an iron tow ball added to the cabling 3, wherein one section of the cable is attached to the attachment means 10 and to the underwater image acquisition apparatus by a second section of the cable to the attachment means 20, and as such, influencing the underwater image acquisition apparatus' buoyancy, thereby determining the height and range of the platform's movement. For example, by moving the tow ball closer to the platform, it causes the platform to sink deeper underwater, while moving the tow bar away from the platform causes the buoyant platform to rise closer to the surface.

The operation mechanism 103 may be, in some embodiments thereof, configured to communicate with the processor unit 101 and configured to send an instruction for the operation of the control module 100 thereof. It may be further configured capable of operating the cable control 111, tow ball control 120. As one example, the cable control 111 may receive an instruction from the operation mechanism 103 to wind or unwind the cabling 3, where such winding causes the platform 2 to acquire a different relative position from the tow unit. In another example, tow ball control 120 may receive an instruction from the operation mechanism 103 to move the tow ball along the length of the cable using a suitable mechanism, such as but not limited to internal gears in the tow ball, rollers, wheels of any such. It is also anticipated that other mechanisms are applicable to this invention that would enable the moving of the tow ball along the length of the cabling. Further still is a propulsion means 10, which for purposes of this disclosure may be one or more of: movement of the tow unit 1, for example by an engine, or movement of the platform 2, for example by means of a cabling winding or a tractor or any such mechanism capable of pulling the platform and causing a displacement of it in the water.

Further still in the FIG. 2, it is illustrated a cabling 3 which connects or attaches the image acquisition apparatus' attachment means 20. A control module 100 is illustrated, which comprises at least in part of a power supply 113, a processor unit 101, a network 108, a positioning means 102, a display apparatus 104, a memory 105, a storage device 110 and a communication module 109. The display apparatus 104 is adapted capable of output of images received by means of the communication module 109 from the underwater image acquisition system 2. On the other hand is a processing unit 101 comprising of at least one or more processors, capable of parallel processing, batch processing, threaded processing or any suitable processing methodology and architecture.

Furthermore, the storage device 110 is adapted capable of storing underwater imagery received from the underwater image acquisition system 2 via a suitable communication module and network, such as a network 108 and communication module 109. On the other hand, the memory 105 is configured with a sequence of instructions executable by a processing unit, wherein execution of said sequence of instructions by a processor unit causes the controller 100 to perform an action of controlling at least in part, some of the assembly or system members. For example, the controller may transmit control signals to the underwater image acquisition system controller module to adapt the light intensity of the lighting module thereof. Also, it may transmit control signals to the underwater image acquisition system controller module to acquire images by means of the an image acquiring apparatus. It may also acquire the position of the tow unit by means of a positioning means 102. In some embodiments, the positioning means comprises of a satellite positioning receiver or any such receivers that may include any one of GPS, GLONASS, NavIC, BeiDou, Galileo, Quasi-Zenith, and which determine the longitude and latitude information of the unit. In other embodiments, the positioning means 102 comprises of a means of determining the position of the underwater image acquisition system relative to the tow unit. In other embodiments, the positioning means 102 comprises of both mechanism of positioning.

Further in the same figure, the communication module 109 is capable of receiving acquired images from the underwater image acquisition system 2, wherein a display apparatus adapted capable of display of images received, and transmitting control signals to the underwater image acquisition system controller module, typically through a network 108. Finally in the figure is attachment means 10 to the underwater image acquisition system via a corresponding attachment means 20, wherein the attachment means comprises of cabling 3, wherein the length of the cabling 3 between the tow unit and the underwater image acquisition system is adaptable by means of a cabling control. The tow ball's relative position on the cabling can be changed by means of a winding mechanism of the cabling by a cabling control 111. It should be noted that a change of the tow ball relative position along the cabling causes an upward or downward movement of a buoyant underwater image acquisition system.

In one embodiment, the controller 100 for the underwater image acquisition system is configured capable of causing the cabling control to adapt the length of the cabling between the tow unit and the underwater image acquisition system.

In another embodiment, the controller 100 for the underwater image acquisition system configured capable of causing the tow ball controller to adapt the tow ball's relative position on the cabling between the tow unit and the underwater image acquisition system.

In one embodiment, the controller 100 for the underwater image acquisition system is configured capable of causing the controller module of the underwater image acquisition system via the communications module to adapt the light intensity of the lighting module by means of varying the amount of power supplied to the module by the power supply.

In one embodiment, the controller 100 for the underwater image acquisition system is configured capable of causing the controller module of the underwater image acquisition system via the communications module to adapt the light intensity of the lighting module by means of varying the number of lighting units in the module.

In one embodiment, the controller 100 for the underwater image acquisition system is configured capable of determining the relative position of the the underwater image acquisition system by means of receiving from a positioning means of an underwater image acquisition system a position measurement; then receiving from a positioning means of a tow unit a position measurement, and determining a position of the underwater image acquisition system relative to a position measurement received from a positioning means of a tow unit.

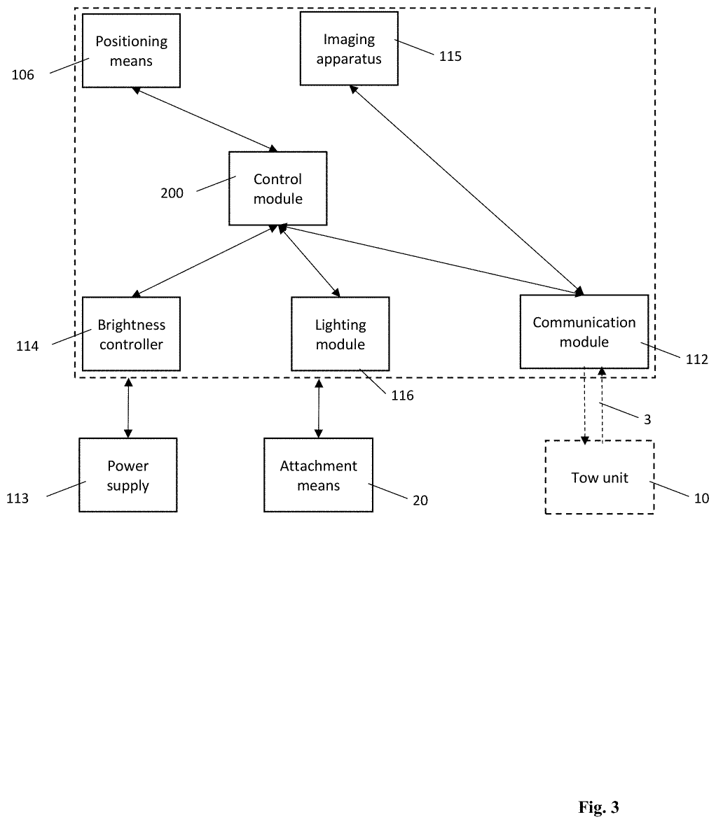

In a further embodiment according to the FIG. 3 of the diagrams it is illustrated a block diagram of some constituent elements of an image acquisition apparatus according to one embodiment of the current invention. Illustrated in the figure is an attachment means 20, which is provided for the attachment of the cabling 3 at a corresponding attachment means 20 described in the previous FIG. 1. On the FIG. 3 is an image acquiring apparatus capable of underwater image acquisition 115, and this may be an optical camera, a general sensor, an infra-red sensor, any such apparatus capable of image acquisition underwater, including radar, sonar, electromagnetic sensors, among others. Also illustrated is the positioning means 106 capable of determining the position of the underwater image acquisition system relative to a known position, and this is preferably relative to the tow unit. Nonetheless, in some embodiments, the positioning means 106 comprises of a satellite positioning receiver or any such receivers that may include any one of GPS, GLONASS, NavIC, BeiDou, Galileo, Quasi-Zenith, and which determine the longitude and latitude information of the unit. In other embodiments, the positioning means 106 comprises of a means of determining the position of the underwater image acquisition system 2 relative to the tow unit. As a consequence, an acquired image's position may further be determined by means of a positioning means supplied thereof.

Further, illustrated is a power supply 113 or any such means that provides electrical power to the system or some parts thereof. While it is preferable that the underwater image acquisition system 2 comprises of a power supply, the power could be supplied by the tow unit using the cabling 3 provided thereof. The power supply could also be a means of generating electrical power based on waves, wind, solar, nuclear, chemical or mechanical means. Also shown is a controller module 200, which is capable of adapting the light intensity due in part from receiving control signals from an external computer system or controller via the communications module. In one embodiment, the controller module 200 is adapted capable of receiving control signals from an external computer system or controller via the communications module to adapt the number of units lighting on the lighting module. In other embodiments, the controller module 200 is adapted capable of varying the amount of power supplied to the lighting module to vary the light intensity. It follows that the lighting module 116 may comprise of either of:

A single light unit with variable light intensity based on power supplied

Multiple light units, each operable independently, wherein one or more of the units can produce light and therefore, vary the light intensity of the module

It is to be understood that a lighting module 116 is capable of supplying light to the image acquiring apparatus 115, and further that the lighting module is capable of adapting the light intensity by means of said controller module for different image lighting conditions. It is also to be understood that a lighting module is only necessary where an optical type of image acquiring apparatus 115 is utilized. The lighting module may comprise of any one or more of an LED, fluorescent bulb, incandescent bulb, or any electric or chemical source of light.

Further provided in the FIG. 3 is a communication module 112 which is capable of transmitting images acquired by the apparatus 115 to an external computer system or controller in a tow unit 1, typically through a network. The communication module is also capable of receiving control signals from an external computer system or controller, typically through a network. The platform is attached to a cabling 3, which includes an attachment means to a tow unit, such as but not limited to a water-based vehicle, ship or land-based towed unit, wherein said attachment means and cabling provides a mechanism of moving the relative position of the underwater image acquisition system relative to the tow unit.

Finally, illustrated in the figure is a brightness controller 114, which may comprise of a photosensitive sensor capable of detecting the lighting condition, including but not limited to the light intensity or any such measurements, where such measurements may be utilized for the adjusting of light intensity of light produced by the lighting module 116.

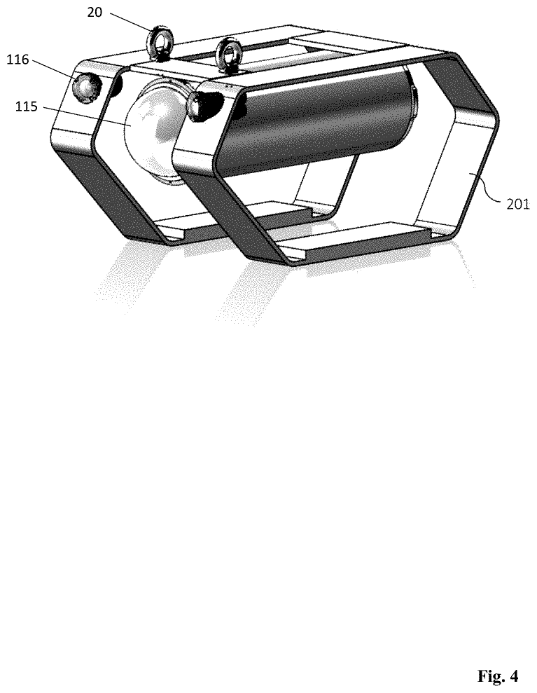

In a further exemplary embodiment according to the FIG. 4 of the diagrams it is illustrated an underwater image acquisition apparatus (platform) of a sledge type configuration. On the figure, it is illustrated an attachment means 20, a lighting module 116, an image acquisition apparatus 115 and a a mounted sledge mechanism 201. The sledge mechanism provides for movement along the floor of the water body, wherein the sledge mechanism preferably further provides a clearance between the floor of the water body and the underwater image acquisition system.

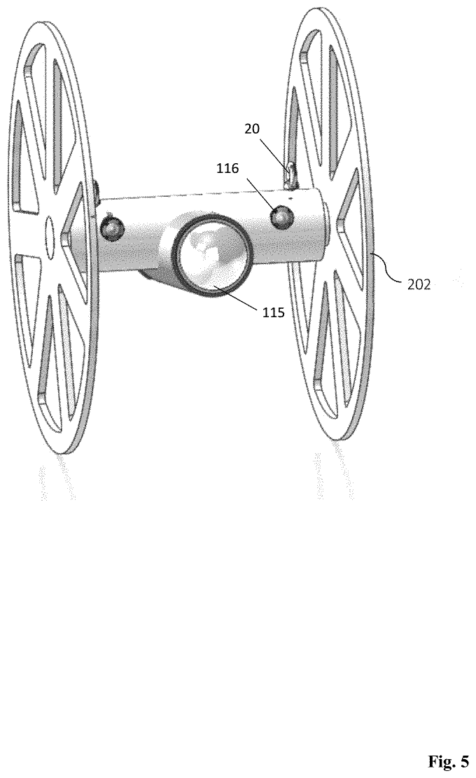

In the exemplary embodiment according to the FIG. 5 of the diagrams it is illustrated an image acquisition apparatus of a wheeled type configuration. On the figure, it is illustrated an attachment means 20, a lighting module 116, an image acquisition apparatus 115 and a mounted wheeled mechanism 202. The mounted wheeled mechanism for movement along the floor of the water body, wherein the wheeled mechanism preferably further provides a clearance between the floor of the water body and the underwater image acquisition system.

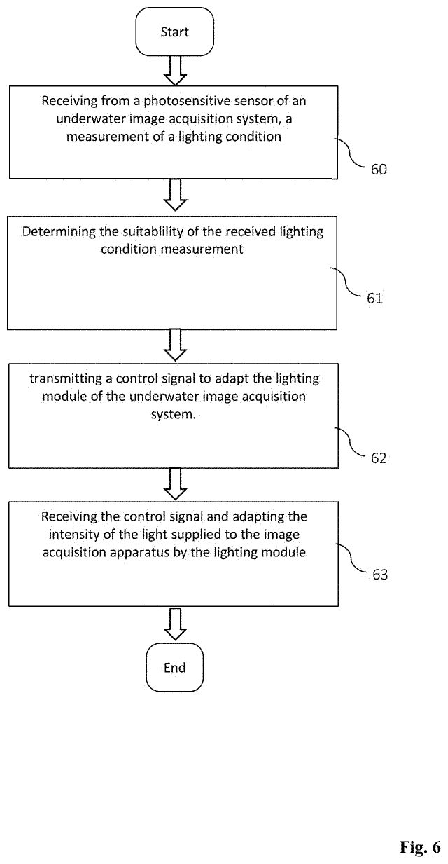

The embodiment according to the FIG. 6 of the diagrams illustrates a process of adapting the light intensity produced by a lighting module at an image acquisition apparatus. The process begins at a step 60, which entails receiving at a tow unit's controller for the underwater image acquisition system, from a photosensitive sensor of an underwater image acquisition system, a measurement of a lighting condition. Next, in the step 61, is determining at the tow unit's controller for the underwater image acquisition system the suitability of the received lighting condition measurement. Subsequently in the step 62, is the transmitting by a tow unit's controller for the underwater image acquisition system a control signal to adapt the lighting module of the underwater image acquisition system. Finally, the step 63 is the receiving at a controller module of the underwater image acquisition system a control signal to adapt the light intensity of light produced by the lighting module and adapting the intensity of the light supplied to the image acquisition apparatus by the lighting module. It should be noted that the intensity of light is adapted by means of varying the amount of power supplied to the module by the power supply or by means of varying the number of lighting units in the module.

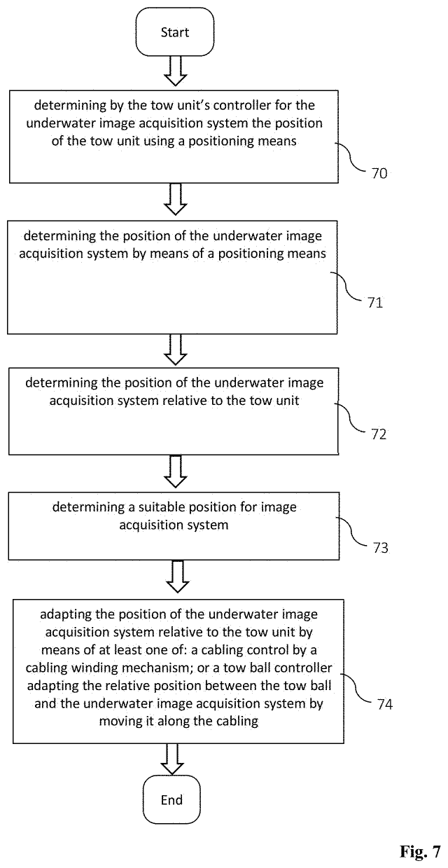

In the final embodiment according to the FIG. 7 of the diagrams illustrates a process of adapting the relative position of an image acquisition apparatus. In a first step 70, is the determining by the tow unit's controller for the underwater image acquisition system the position of the tow unit using a positioning means supplied thereof. The next step 71, is the determining of the position of the underwater image acquisition system by means of a positioning means supplied thereof. Subsequently in 72, is the determining of the position of the underwater image acquisition system relative to the tow unit. The step 73 entails the determining of a suitable position for image acquisition system. Finally, the step 74 is adapting the position of the underwater image acquisition system relative to the tow unit by means of at least one of: a cabling control by a cabling winding mechanism; or a tow ball controller adapting the relative position between the tow ball and the underwater image acquisition system by moving it along the cabling length.

In one embodiment, the relative position between the tow ball and a buoyant underwater image acquisition system is adaptable, wherein a change of the tow ball relative position along the cabling causes an upward or downward movement of a buoyant underwater image acquisition system.

In another embodiment, the tow ball's relative position on the cabling can be changed by means of a winding mechanism of the cabling by a cabling control.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICATION

The current invention relates to the manufacture of towed underwater image acquisition systems, apparatus and their methods of use.

What is claimed is:

1. An underwater image acquisition system, the system comprising of:
an image acquiring apparatus capable of underwater image acquisition, wherein an acquired image's position may further be determined by means of a positioning means supplied thereof;
a power supply or any such means that provides electrical power;
a controller module;
a positioning means capable of determining the position of the underwater image acquisition system relative to a known position;
a communication module capable of:
transmitting acquired images to an external computer system or controller, typically through a network, and;
receiving control signals from an external computer system or controller, typically through a network, and;
an attachment means to a tow unit, such as but not limited to a water-based vehicle, ship or land-based towed unit, wherein said attachment means provides a mechanism of moving the relative position of the underwater image acquisition system relative to the tow unit.

2. The system in claim 1, further comprising a lighting module capable of supplying light to the image acquiring apparatus, wherein, said lighting module is capable of adapting the light intensity by means of a controller module (or any similar means thereof) for different image lighting conditions;

3. The system in claim 1, further comprising of a photosensitive sensor capable of detecting the lighting condition, including but not limited to the light intensity.

4. The system in claim 1, wherein the attachment means comprises a cabling with a tow ball, wherein said tow ball is capable of movement along the cabling, wherein the movement of the tow ball along the cabling causes an upward or downward movement of a buoyant underwater image acquisition system.

5. The system in claim 1, wherein the positioning means comprises of a satellite positioning receiver or any such receivers that may include any one of GPS, GLONASS, NavIC, BeiDou, Galileo, Quasi-Zenith.

6. The system in claim 1, wherein the positioning means comprises of a means of determining the position of the underwater image acquisition system relative to the tow unit.

7. The system in claim 1, further comprising of a mounted wheeled mechanism for movement along the floor of the water body, wherein said wheeled mechanism provides a clearance between the floor of the water body and the underwater image acquisition system.

8. The system in claim 1, further comprising of a mounted sledge mechanism for movement along the floor of the water body, wherein said sledge mechanism provides a clearance between the floor of the water body and the underwater image acquisition system.

9. The system in claim 1, wherein the lighting module comprises of a plurality of lighting units, which may be controlled to light separately thus adapting the light intensity of the module.

10. The system as in claim 1, wherein the lighting module comprises of a single light source capable of emitting light of different intensity depending on the amount of power supplied to the module.

11. The system as in claim 1, wherein the controller module is adapted capable of receiving control signals from an external computer system or controller via the communications module to adapt the light intensity of the lighting module by means of varying the amount of power supplied to the module by the power supply.

12. The system as in claim 1, wherein the controller module is adapted capable of receiving control signals from an external computer system or controller via the communications module to adapt the light intensity of the lighting module by means of varying the number of lighting units in the module.

13. A tow unit for an underwater image acquisition system comprising of:
a controller for the underwater image acquisition system comprising of:
a display apparatus adapted capable of output of images received by means of the communication module from the underwater image acquisition system;
a processing unit comprising of at least one or more processors;
a storage device;
a memory configured with a sequence of instructions executable by a processing unit, wherein execution of said sequence of instructions by a processor unit causes the controller to:
transmit control signals to the underwater image acquisition system controller module to adapt the light intensity of the lighting module;
transmit control signals to the underwater image acquisition system controller module to acquire images by means of the an image acquiring apparatus;
an input mechanism capable of receiving control signals for the control of the underwater image acquisition system;
a communication module capable of:
receiving acquired images from the underwater image acquisition system, and;
transmitting control signals to the underwater image acquisition system controller module, typically through a network;
a display apparatus adapted capable of display of images received by means of the communication module from the underwater image acquisition system;
a positioning means capable of determining the position of the tow unit;
a propulsion mechanism capable of causing by means of an attachment means, the moving of the underwater image acquisition system relative to an underwater position, and;
an attachment means to the underwater image acquisition system, said attachment means comprising of cabling, wherein the length of the cabling between the tow unit and the underwater image acquisition system is adaptable by means of a cabling control.

14. The tow unit as in claim 13, wherein the cabling control comprises of a cabling winding mechanism.

15. The tow unit as in claim 13, wherein the attachment means comprises a cabling with a tow ball, wherein the relative position between the tow ball and a buoyant underwater image acquisition system is adaptable, wherein a change of the tow ball relative position along the cabling causes an upward or downward movement of a buoyant underwater image acquisition system.

16. The tow unit as in claim 13, wherein the tow ball's relative position on the cabling can be changed by means of a tow ball controller.

17. The tow unit as in claim 13, wherein the tow ball's relative position on the cabling can be changed by means of a winding mechanism of the cabling by a cabling control.

18. The tow unit in claim 13, wherein the positioning means comprises of a satellite positioning receiver or any such receivers that may include any one of GPS, GLONASS, NavIC, BeiDou, Galileo, Quasi-Zenith.

19. The tow unit in claim 13, wherein the positioning means comprises of a means of determining the position of the underwater image acquisition system relative to the tow unit.

20. The tow unit as in claim 13, wherein the controller for the underwater image acquisition system is configured capable of causing the cabling control to adapt the length of the cabling between the tow unit and the underwater image acquisition system.

21. The tow unit as in claim 13, wherein the controller for the underwater image acquisition system is configured capable of causing the tow ball controller to adapt the tow ball's relative position on the cabling between the tow unit and the underwater image acquisition system.

22. The tow unit as in claim 13, wherein the controller for the underwater image acquisition system is configured capable of causing the controller module of the underwater image acquisition system via the communications module to adapt the light intensity of the lighting module by means of varying the amount of power supplied to the module by the power supply.

23. The tow unit as in claim 13, wherein the controller for the underwater image acquisition system is configured capable of causing the controller module of the underwater image acquisition system via the communications module to adapt the light intensity of the lighting module by means of varying the number of lighting units in the module.

24. The tow unit as in claim 13, wherein the controller for the underwater image acquisition system is configured capable of determining the relative position of the the underwater image acquisition system by means of:
receiving from a positioning means of an underwater image acquisition system a position measurement;
receiving from a positioning means of a tow unit a position measurement, and;
determining a position of the underwater image acquisition system relative to a position measurement received from a positioning means of a tow unit.

25. A method comprising of:
receiving at a tow unit's controller for the underwater image acquisition system, from a photosensitive sensor of an underwater image acquisition system, a measurement of a lighting condition;
determining at the tow unit's controller for the underwater image acquisition system the suitability of the received lighting condition measurement, and;
transmitting by a tow unit's controller for the underwater image acquisition system a control signal to adapt the lighting module of the underwater image acquisition system.

26. The method of claim 25, further comprising of:
receiving at a controller module of the underwater image acquisition system a control signal to adapt the light intensity of light produced by the lighting module;
adapting the intensity of the light supplied to the image acquisition apparatus by the lighting module.

27. The method of claim 26, wherein the intensity of light is adapted by means of varying the amount of power supplied to the module by the power supply.

28. The method of claim 26, wherein the intensity of light is adapted by means of varying the number of lighting units in the module.

29. A method comprising of:
determining by the tow unit's controller for the underwater image acquisition system the position of the tow unit using a positioning means supplied thereof;
determining the position of the underwater image acquisition system by means of a positioning means supplied thereof;
determining the position of the underwater image acquisition system relative to the tow unit;
determining a suitable position for image acquisition system, and;
adapting the position of the underwater image acquisition system relative to the tow unit by means of at least one of: a cabling control by a cabling winding mechanism;
or a tow ball controller adapting the relative position between the tow ball and the underwater image acquisition system by moving it along the cabling length.

30. The method of claim 29, wherein the relative position between the tow ball and a buoyant underwater image acquisition system is adaptable, wherein a change of the tow ball relative position along the cabling causes an upward or downward movement of a buoyant underwater image acquisition system.

31. The method of claim 29, wherein the tow ball's relative position on the cabling can be changed by means of a winding mechanism of the cabling by a cabling control.
